(19) United States
(12) Patent Application Publication
(10) Pub. No.: US 2026/0079427 A1
(43) Pub. Date: Mar. 19, 2026

(54) IMAGE FORMING APPARATUS

(71) Applicant: CANON KABUSHIKI KAISHA, Tokyo (JP)

(72) Inventors: Noritomo Yamaguchi, Kanagawa (JP); Kazuki Matsumoto, Shizuoka (JP)

(21) Appl. No.: 19/324,348

(22) Filed: Sep. 10, 2025

(30) Foreign Application Priority Data
Sep. 13, 2024 (JP) 2024-159538

(51) Int. Cl. G03G 15/08

(52) U.S. Cl. CPC G03G 15/0891; G03G 15/0865; G03G 15/0881

(57) ABSTRACT

An image forming apparatus includes a cartridge, an apparatus body including a pump portion, a developer container including a toner accommodating portion, and a tube. The cartridge includes a toner chamber, a filter, an air chamber, a discharge port, and a pipe. While the toner conveyance operation is performed, a pressure difference between the toner chamber and the air chamber in a first state in which the toner is loaded on only a part of the partition portion of the filter is greater than a pressure difference between the toner chamber and the air chamber in a second state in which no toner is loaded on an entire surface of the partition portion of the filter.

### BACKGROUND

Field of the Technology

The present disclosure relates to image forming apparatuses that convey toner together with air.

### Description of the Related Art

In general, image forming apparatuses that adopt an electrophotographic system form images by transferring toner images formed on a surface of a photosensitive drum onto a transfer material serving as a transfer medium. Known methods related to replenishing developer include a process cartridge system and a toner replenishing system. The process cartridge system relates to a system in which the photosensitive drum and a developer container are integrated as a process cartridge, and when developer runs out, the process cartridge is replaced with a new cartridge.

Meanwhile, the toner replenishing system is a system in which new toner is replenished to the developing container when toner runs out. Hitherto, an image forming apparatus that includes a powder supplying device including a powder accommodating portion for accommodating toner and capable of supplying toner to a toner hopper disposed on the image forming apparatus body has been proposed (refer to Japanese Patent Application Laid-Open Publication No. 2007-249151). The powder supplying device includes an air pump that discharges air toward the powder accommodating portion, and a suction pump that sucks toner accommodated in the powder accommodating portion toward the toner hopper.

### SUMMARY

According to a first aspect of the present disclosure, an image forming apparatus includes a cartridge configured to accommodate toner, and an apparatus body to which the cartridge is detachably attached, the apparatus body including a pump portion configured to discharge air, a developer container including a toner accommodating portion configured to accommodate the toner, and a tube configured to convey the toner discharged together with air from the cartridge to the toner accommodating portion of the developer container. The cartridge includes a toner chamber configured to accommodate the toner, a filter configured to block passage of the toner while allowing passage of air, an air chamber arranged adjacent to the toner chamber via the filter, the air chamber being provided with an intake port that takes in air discharged from the pump portion, a discharge port configured to discharge the toner accommodated in the toner chamber to an exterior of the cartridge, and a pipe configured to communicate with the discharge port and through which the toner discharged from the discharge port passes. While a toner conveyance operation is performed in which the toner in the toner chamber is discharged from the discharge port and conveyed through the tube to the toner accommodating portion by air discharged from the pump portion and taken in through the intake port of the cartridge, (i) a pressure of the pump portion, a pressure of the air chamber, a pressure of the toner chamber, and a pressure of the toner accommodating portion are equal to or greater than atmospheric pressure, (ii) the pressure of the toner chamber is greater than the pressure of the toner accommodating portion, and (iii) the pressure of the air chamber is greater than the pressure of the toner chamber. The filter includes a partition portion configured to partition the toner chamber and the air chamber such that at least a portion of the toner chamber is positioned above the air chamber in a gravity direction. While the toner conveyance operation is performed, a pressure difference between the toner chamber and the air chamber in a first state in which the toner is loaded on only a part of the partition portion of the filter is greater than a pressure difference between the toner chamber and the air chamber in a second state in which no toner is loaded on an entire surface of the partition portion of the filter.

According to a second aspect of the present disclosure, an image forming apparatus includes a cartridge configured to accommodate toner, an apparatus body to which the cartridge is detachably attached, the apparatus body including a pump portion configured to discharge air, a developer container including a toner accommodating portion configured to accommodate the toner, and a tube configured to convey the toner discharged together with air from the cartridge to the toner accommodating portion of the developer container. The cartridge includes a toner chamber configured to accommodate the toner, a first filter configured to block passage of the toner while allowing passage of air, an air chamber arranged adjacent to the toner chamber via the filter, the air chamber being provided with an intake port that takes in air discharged from the pump portion, a discharge port configured to discharge the toner accommodated in the toner chamber to an exterior of the cartridge, and a pipe configured to communicate with the discharge port and through which the toner discharged from the discharge port passes, the toner in the toner chamber being discharged from the discharge port and conveyed through the tube to the toner accommodating portion by air discharged from the pump portion and taken in through the intake port of the cartridge. The developer container is provided with an opening configured to communicate the toner accommodating portion with an exterior of the developer container. The developer container includes a second filter configured to cover the opening and to block passage of the toner while allowing passage of air. An air permeability of the first filter is lower than an air permeability of the second filter.

Features of the present disclosure will become apparent from the following description of embodiments with reference to the attached drawings. The following description of embodiments is described by way of example.

### BRIEF DESCRIPTION OF THE DRAWINGS

FIG. 1 is an entire schematic diagram of an image forming apparatus according to a first embodiment.

FIG. 2 is a cross-sectional view of a process cartridge.

FIGS. 3A and 3B are each a cross-sectional view of a toner cartridge, wherein FIG. 3A illustrates a state in which a lid member is opened, and FIG. 3B illustrates a state in which the lid member is closed.

FIG. 4 is a perspective view of the toner cartridge cut at an XY plane.

FIG. 5 is an exploded perspective view of the toner cartridge cut at the XY plane.

FIG. 6 is a perspective view of a filter.

FIG. 7 is an enlarged view of a joint portion of a first frame body and a second frame body.

FIG. 8 is a bottom view illustrating the first frame body.

FIG. 9 is a cross-sectional view illustrating a state in which the toner cartridge is connected via a passage to a developer container.

FIG. 10 is a graph illustrating a pressure at each portion in a state where pressure generated at a pump is transmitted from the toner cartridge to the process cartridge.

FIG. 11A is a cross-sectional view illustrating a state in which discharge of toner is not started.

FIG. 11B is a cross-sectional view illustrating a state in which discharge of toner has been started by air being taken in through an intake port.

FIG. 11C is a cross-sectional view illustrating a state in which toner has been discharged further from the state illustrated in FIG. 11B.

FIG. 11D is a cross-sectional view illustrating a state in which a portion of an inclined portion of the filter is exposed.

FIG. 12 is a table illustrating whether toner conveyance is possible according to respective conditions.

FIG. 13 is a graph illustrating a relationship between pump flow rate and pressure difference between air chamber and toner chamber.

### DESCRIPTION OF THE EMBODIMENTS

Dimensions, materials, shapes, and relative arrangements of components described in the following description of embodiments may be modified arbitrarily according to the configuration of apparatuses and various conditions.

Examples of image forming apparatuses according to the following description include a copying machine, a printer, a multifunction machine, and a commercial printing apparatus. In such image forming apparatuses, images are formed on recording materials based on image information entered from an external apparatus or image information read from a document. The image forming apparatus may include, in addition to a main body having an image forming function, auxiliary devices such as an option feeder, an image reading apparatus, and a sheet processing apparatus connected thereto, and in that case, the entire system including the connected auxiliary device is also referred to as one type of the image forming apparatus. The recording material may include sheets of various materials and shapes, such as paper including normal paper and thick paper, plastic films, coated paper, sheets having special shapes such as envelopes and index paper, and cloths.

### Entire Configuration

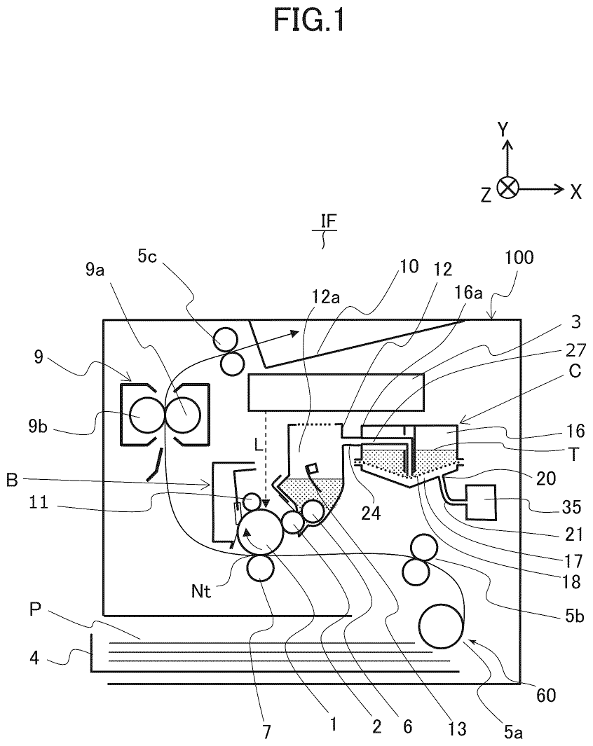

An image forming apparatus IF according to the present embodiment is a monochrome laser beam printer adopting an electrophotographic system. The image forming apparatus IF includes, as illustrated in FIG. 1, an image forming unit 50 for forming an image on a sheet P, a sheet feed unit 60, a fixing unit 9, and a sheet discharge roller pair 5c. The image forming unit 50 includes a process cartridge B, and a scanner unit 3. The scanner unit 3 is arranged above the process cartridge B. Alternatively, instead of the scanner unit 3, an LED exposing unit including an LED array in which a plurality of LEDs are aligned along a longitudinal direction of the photosensitive drum 1 may be adopted.

The portion having excluded the process cartridge B and a toner cartridge C which will be described later from the image forming apparatus IF may sometimes be referred to as a main body of the image forming apparatus IF, or an apparatus body 100. In the following description, the toner cartridge C may be referred to simply as cartridge C. The process cartridge B may be supported attachably and detachably with respect to the apparatus body 100 or may be fixed in a non-detachable manner with respect to the apparatus body 100.

Further, in the following description, unless denoted otherwise, directions (X, Y, Z) are defined as follows, assuming that the process cartridge B and the toner cartridge C take a normal position, that is, a position at which the cartridges are attached to the apparatus body 100.

As illustrated in FIG. 1, a front-rear direction is denoted by an X axis, and a direction from a rear side toward a front side of the image forming apparatus IF is referred to as an X direction. The X direction may be referred to as a front direction. Further, a downstream side in the X direction of the image forming apparatus IF may be referred to as a front side, and an upstream side may be referred to as a rear side.

A right-left direction is denoted by a Z axis, and a direction from left to right of the image forming apparatus IF is referred to as a Z direction. The Z direction may also be referred to as a right direction. Further, a downstream side in the Z direction of the image forming apparatus IF may be referred to as a right side, and an upstream side thereof may be referred to as a left side.

An up-down direction is denoted by a Y axis, and a direction from down to up of the image forming apparatus IF is referred to as a Y direction. The Y direction may also be referred to as an upper direction, a height direction, or a vertical direction. Further, the downstream side in the Y direction of the image forming apparatus IF may be referred to as an upper side, an upper surface side, or a top surface side, and the upstream side may be referred to as a lower side, a lower surface side, or a bottom surface side.

The X axis, the Y axis, and the Z axis are in a mutually perpendicular relationship. For example, the X axis is perpendicular to the Y axis, and is also perpendicular to the Z axis. Further, the plane perpendicular to the X axis may be referred to as a YZ plane, a plane perpendicular to the Y axis may be referred to as a ZX plane, and a plane perpendicular to the Z axis may be referred to as an XY plane. For example, an XZ plane is a horizontal plane. The X direction and the Z direction are directions along the XZ plane which is the horizontal plane, or in other words, are a horizontal direction.

The process cartridge B includes the photosensitive drum 1, a developing roller 2, a charging roller 11, and a developer container 12 including a toner accommodating portion 12a that accommodates toner to be supplied to the developing roller 2. The photosensitive drum 1 is composed by coating an organic photoconductive layer on an outer circumference of an aluminum cylinder, and it is rotated by a drive motor not shown. Alternatively, a photosensitive belt may be used instead of the photosensitive drum 1.

The image forming unit 50 includes a transfer roller 7 that comes into contact with the developing roller 2 of the process cartridge B and that forms a transfer portion Nt. The transfer roller 7 comes into contact with the photosensitive drum 1 of the process cartridge B and forms the transfer portion Nt.

The fixing unit 9 includes a heating roller 9a heated by a heater, and a pressing roller 9b that comes into pressure contact with the heating roller 9a. Alternatively, a fixing film that slides against a heater and rotates or a fixing belt having a conductive layer that is heated by electromagnetic induction heating may be applied instead of the heating roller 9a.

The sheet feed unit 60 is disposed at a lower portion of the image forming apparatus IF. The sheet feed unit 60 includes a tray 4 that may be drawn out from or attached to the apparatus body 100, and a feed roller 5a for feeding the sheets P accommodated in the tray 4.

The toner cartridge C is supported attachably and detachably to and from the apparatus body 100. The toner cartridge C accommodates toner T that may be supplied to the toner accommodating portion 12a of the developer container 12 in the process cartridge B.

### Image Forming Operation

Next, an image forming operation of the image forming apparatus IF configured as above will be described. When an image signal is entered to the scanner unit 3 from a personal computer not shown, a laser light L corresponding to the image signal is irradiated from the scanner unit 3 onto the photosensitive drum 1 of the process cartridge B.

In this state, a surface of the photosensitive drum 1 has been charged uniformly in advance to a predetermined polarity and potential by the charging roller 11, and by having the laser light L irradiated thereon from the scanner unit 3, an electrostatic latent image is formed on a surface thereof. The electrostatic latent image formed on the photosensitive drum 1 is developed by the developing roller 2, and a toner image is formed on the photosensitive drum 1.

In parallel with this image forming process, the sheet P being accommodated in the tray 4 of the sheet feed unit 60 is conveyed toward the transfer portion Nt. In the transfer portion Nt, a toner image on the photosensitive drum 1 is transferred onto the sheet P by a secondary transfer bias applied to the transfer roller 7. After having the toner image transferred onto the sheet P, toner remaining on the surface of the photosensitive drum is removed by a cleaning device not shown.

Predetermined heat and pressure are applied by the heating roller 9a and the pressing roller 9b of the fixing unit 9 to the sheet P having the toner image transferred thereto, by which toner is melted and solidified, i.e., fixed. The sheet P having passed through the fixing unit 9 is discharged toward a direction along the X direction by the sheet discharge roller pair 5c, and supported on a sheet discharge tray 10 disposed on an upper portion of the apparatus body 100.

### Process Cartridge

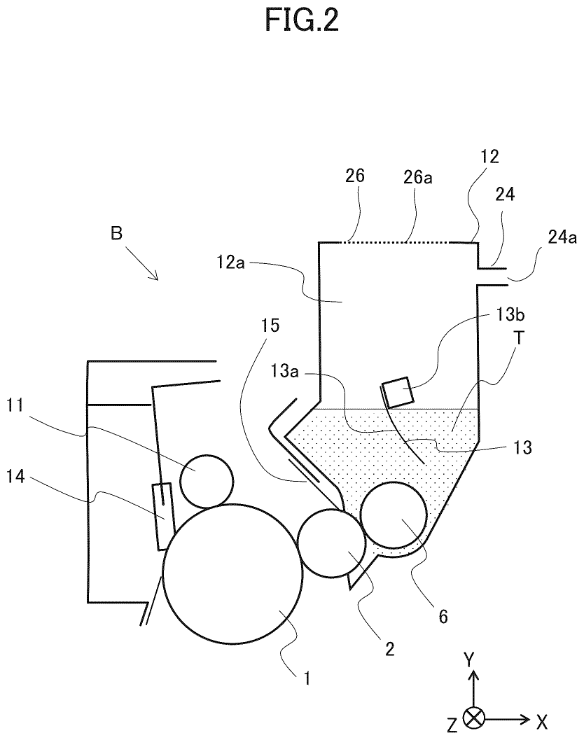

Next, the process cartridge B will be described in further detail with reference to FIG. 2. FIG. 2 is a cross-sectional view illustrating the process cartridge B. The process cartridge B includes the photosensitive drum 1 and a processing unit that acts on the photosensitive drum 1. In the present embodiment, the processing unit includes the charging roller 11, the developing roller 2, a developing blade 15, and a cleaning blade 14.

Further, the process cartridge B is composed of a drum unit serving as an image bearing member unit, and a developing unit serving as an image developing unit. The drum unit includes the charging roller 11 positioned in the circumference of the photosensitive drum 1 and the cleaning blade 14 having elasticity. The developing unit includes the developing roller 2, the developing blade 15, a supply roller 6, the developer container 12 including the toner accommodating portion 12a that accommodates toner T, and an agitating member 13.

The agitating member 13 includes a rotation shaft 13a, and an agitating sheet 13b fixed to the rotation shaft 13a and having flexibility, the agitating member 13 agitating the toner T accommodated in the toner accommodating portion 12a by rotating. Further, the developer container 12 includes a passage 24 through which toner supplied from the toner cartridge C passes, an intake port 24a through which supplied toner is taken in, and an opening 26 through which air within the toner accommodating portion 12a is passed through to an exterior of the developer container 12. In the position during use of the image forming apparatus IF, the intake port 24a and the opening 26 are disposed on an upper portion of the developer container 12, and the opening 26 is covered by a filter 26a serving as a second filter. According to the present embodiment, the opening 26 is formed of a through hole through which an interior of the toner accommodating portion 12a and the exterior of the developer container 12 are communicated. The filter 26a is composed of a porous member formed of resin fiber, for example. The pores of the filter 26a are designed to have a size and density that allows air to pass through and that regulates the passing of toner T. In other words, the filter 26a is configured to allow passage of air and to block passage of toner T.

### General Configuration of Toner Cartridge

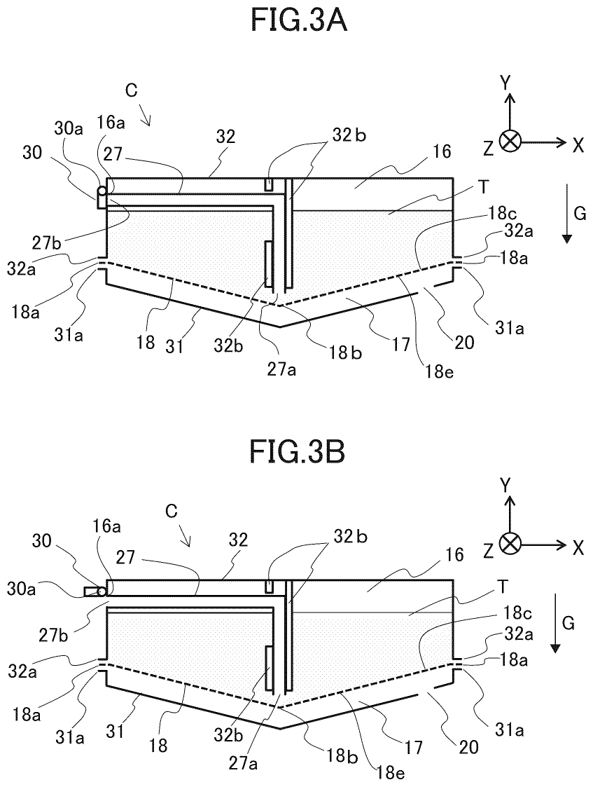

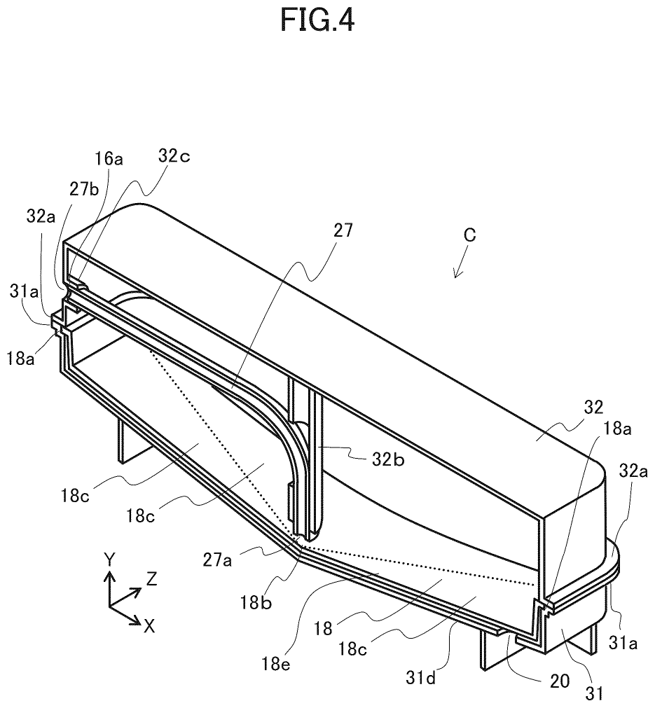

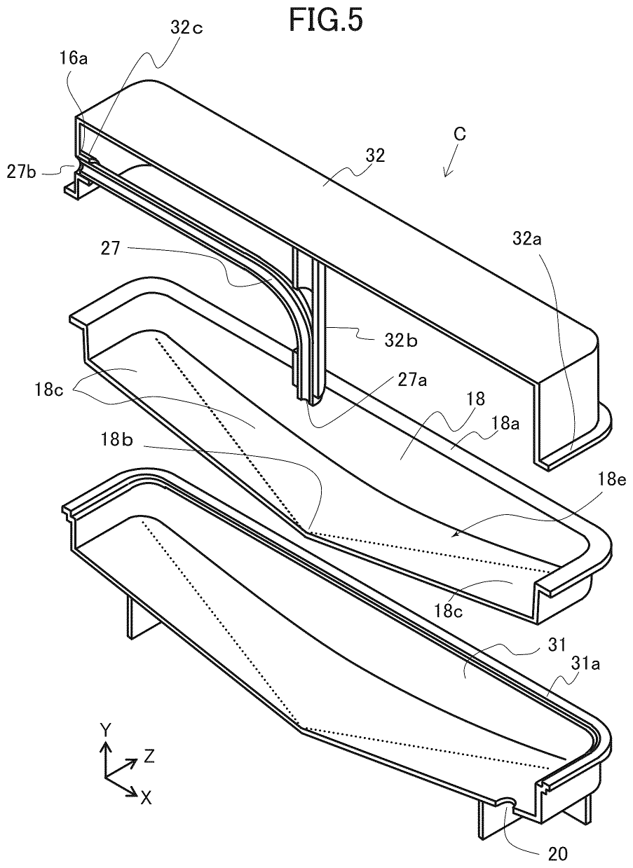

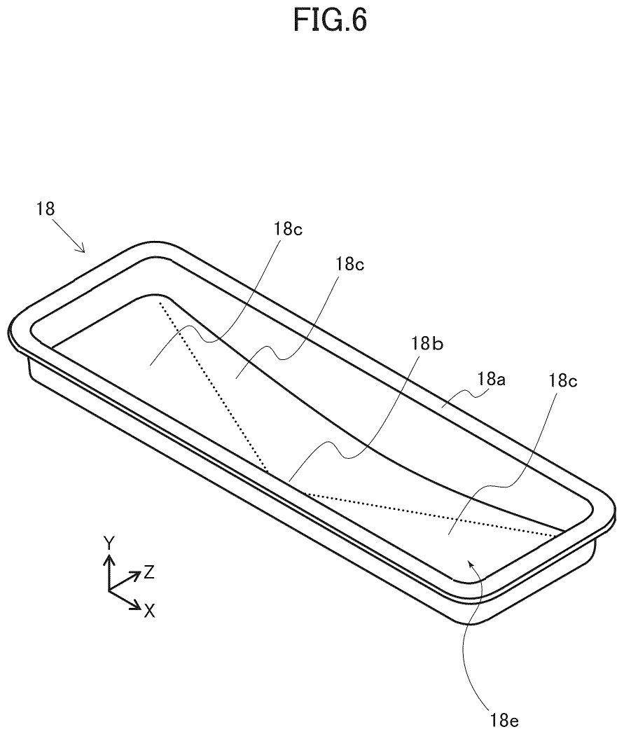

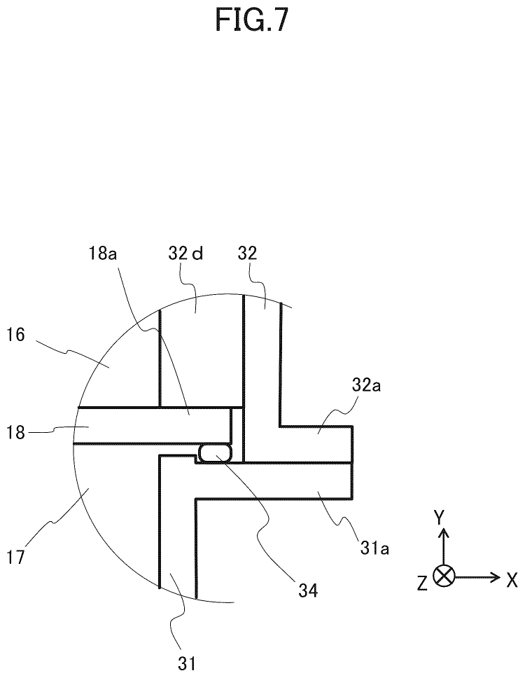

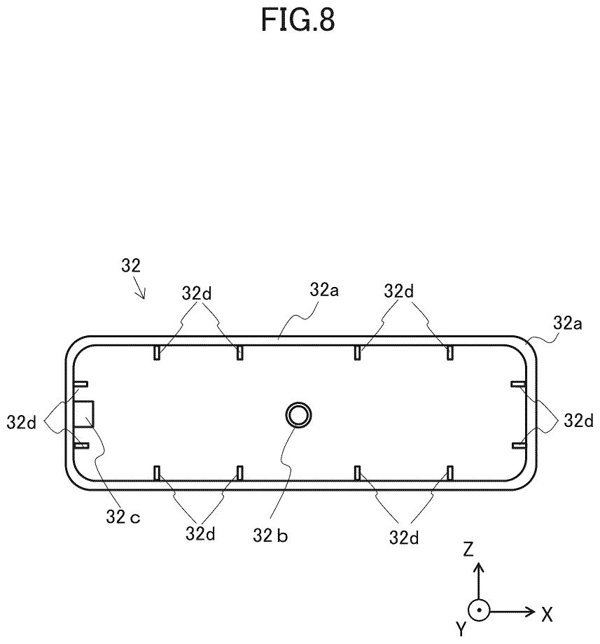

Next, with reference to FIGS. 3A to 8, the general configuration of the toner cartridge C will be described. FIG. 3A is a cross-sectional view of the toner cartridge C with a lid member 30 opened, and FIG. 3B is a cross-sectional view of the toner cartridge C with the lid member 30 closed. FIG. 4 is a perspective view of the toner cartridge C cut at an XY plane. FIG. 5 is an exploded perspective view of the toner cartridge C cut at the XY plane. FIG. 6 is a perspective view illustrating a filter 18. FIG. 7 is an enlarged view illustrating a joint portion of a first frame body 32 and a second frame body 31. FIG. 8 is a bottom view illustrating the first frame body 32.

The image forming apparatus IF includes a front door not shown that is supported in an openable and closable manner with respect to the casing of the apparatus body 100. The front door covers an opening formed on a front portion of the apparatus body 100, that is, disposed at a downstream end portion in the X direction, by being positioned at a closed position. The front door opens the opening of the apparatus body 100 by being positioned at an opened position. The front door may maintain its position at the opened position.

When the front door is opened from the closed position to the opened position, the toner cartridge C is exposed to the exterior of the image forming apparatus IF through the opening. Thereby, the user may be able to access the toner cartridge C.

The toner cartridge C is arranged on a downstream side in the X direction of the apparatus body 100, that is, on the front side of the apparatus body 100. In other words, the toner cartridge C is arranged on the downstream side of the apparatus body 100 in a sheet discharging direction of the sheet discharge roller pair 5c.

The toner cartridge C is supported attachably and detachably in the X direction with respect to the apparatus body 100. Therefore, the toner cartridge C may be replaced without removing the process cartridge B from the apparatus body 100. The toner cartridge C is arranged on the front side of the apparatus body 100 and exposed by opening the front door, such that they may be replaced easily.

In the following description, unless denoted otherwise, directions (X, Y, Z) are defined as illustrated in FIGS. 3A to 11D assuming that the toner cartridge C takes the position described below. That is, the following description assumes that the toner cartridge C takes a position in which a toner chamber 16, the filter 18, and an air chamber 17 of the toner cartridge C are aligned in this order from the upper direction with respect to a gravity direction G, which is a direction opposite to the Y direction (refer to FIG. 3A), which corresponds to a position of the toner cartridge C in which a short direction, i.e., Z direction, and a longitudinal direction, i.e., X direction, of the toner cartridge C are parallel to a horizontal direction perpendicular to the gravity direction G.

In this position, the toner cartridge C is oriented in a predetermined orientation such that the gravity direction is the direction opposite to the Y direction and that at least a portion of the toner chamber 16 is positioned above the air chamber 17. The short direction of the toner cartridge C in this state is referred to as the Z direction, the longitudinal direction is referred to as the X direction, and the opposite direction to the gravity direction is referred to as the Y direction. That is, the gravity direction G is the direction along which the second frame body 31 and the first frame body 32 described later are aligned. In other words, the gravity direction G is the direction along which the toner chamber 16 and the air chamber 17 are aligned. The X direction is the longitudinal direction of the toner cartridge C when viewed in the gravity direction G. The Z direction is a short direction of the first frame body 32 intersecting both the X direction and the Y direction, and it is also a longitudinal direction of the developer container 12.

A front-rear direction of the toner cartridge C is denoted by the X axis, and the direction from the rear side toward the front side is referred to as the X direction. The X direction may also be referred to as the front direction. A downstream side in the X direction of the toner cartridge C may be referred to as the front side, and an upstream side thereof may be referred to as the rear side.

The right-left direction of the toner cartridge C is denoted by the Z axis, and the direction from left to right of the toner cartridge C is referred to as the X direction. The Z direction may also be referred to as the right direction. Further, the downstream side in the Z direction of the toner cartridge C may be referred to as the right side, and the upstream side thereof may be referred to as the left side.

The up-down direction of the toner cartridge C is denoted by the Y axis, and the direction from down to up of the toner cartridge C is referred to as the Y direction. The Y direction may also be referred to as the upper direction, the height direction, or the vertical direction. Further, the downstream side in the Y direction of the toner cartridge C may be referred to as the upper side, the upper surface side, or the top surface side, and the upstream side may be referred to as the lower side, the lower surface side, or the bottom surface side.

The toner cartridge C includes, as illustrated in FIGS. 3A to 5, the first frame body 32 serving as a first container, the second frame body 31 serving as a second container, the filter 18, and a discharge pipe 27 serving as a pipe. In the present embodiment, the first frame body 32 and the second frame body 31 are formed of a resin material, but they may also be formed of paper. The filter 18 is retained in a state sandwiched between the first frame body 32 and the second frame body 31, as will be described in detail later.

An interior space of the toner cartridge C is partitioned by the filter 18 into the toner chamber 16 and the air chamber 17. That is, the toner chamber 16 is composed of the first frame body 32 and the filter 18, and the air chamber 17 is composed of the second frame body 31 and the filter 18. The air chamber 17 is arranged below the filter 18, and the toner chamber 16 is arranged above the filter 18. That is, the air chamber 17 is adjacent to the toner chamber 16 via the filter 18. No partition is provided in the air chamber 17, and the air chamber 17 is the only chamber, i.e., room or space, that is adjacent to the toner chamber 16 via the filter 18.

The toner chamber 16 is configured to accommodate toner T, and toner T is supported by the filter 18 in the gravity direction within the toner chamber 16. Toner T is not accommodated in the air chamber 17. The filter 18 is composed of a porous member formed of resin fiber, for example. The pores of the filter 18 are designed to have a size and density that allows air to pass through and regulates the passing of toner T. In other words, the filter 18 serving as a first filter is configured to allow passage of air and to block passage of toner T.

A discharge port 16a through which toner within the toner chamber 16 is discharged to the exterior of the toner cartridge C is disposed on the rear side of the first frame body 32. In other words, the discharge port 16a is disposed on the toner chamber 16. The discharge port 16a is composed of a through hole that passes through the first frame body 32 in the X direction. An intake port 20 composed of a port that passes through the second frame body 31 in the Y direction is disposed on a lower surface 31d of the second frame body 31. In other words, the intake port 20 is disposed on the air chamber 17. The discharge port 16a and the intake port 20 are communicated with the exterior of the toner cartridge C.

The apparatus body 100 of the image forming apparatus IF includes, as illustrated in FIG. 1, a pump 35 serving as a pump portion, and an air supply pipe 21. The air supply pipe 21 connects the pump 35 and the intake port 20 of the toner cartridge C, and the pump 35 is configured to supply air to the air chamber 17 of the toner cartridge C via the air supply pipe 21. The pump 35 is arranged below the toner cartridge C. The pump 35 is composed of a positive displacement pump, such as a reciprocating pump or a rotary pump, but is not limited thereto. For example, the pump 35 may be composed of a non-positive displacement pump, such as a centrifugal pump, a propeller pump, or a viscosity pump.

The reciprocating pump is a pump that performs suction and discharge through reciprocation of a piston or a plunger, and examples of the reciprocating pump include a piston pump, a plunger pump, and a diaphragm pump. The rotary pump is a pump that performs suction and discharge by rotation of a gear or a rotor, and examples of the rotary pump include a gear pump, a screw pump, and a vane pump. The pump 35 according to the present embodiment is composed of a diaphragm pump as an example.

In the present embodiment, the pump 35 is connected to the intake port 20 via the air supply pipe 21, but the present technique is not limited thereto. For example, the pump 35 may be directly connected to the intake port 20 of the toner cartridge C, or may be connected to the intake port 20 via the passage composed of the frame body of the apparatus body 100.

According to the present embodiment, the pump 35 is disposed on the apparatus body 100, but alternatively, the pump may be disposed respectively on the toner cartridge C and the process cartridge B.

The discharge port 16a disposed on the first frame body 32 of the toner cartridge C is opened toward the upstream side in the X direction. Therefore, when attaching the toner cartridge C toward the upstream side in the X direction with respect to the apparatus body 100, the discharge port 16a may be easily engaged to be communicated with the passage 24.

The arrangement is not limited to that described above, and the discharge port 16a may be disposed on the lower surface 31d or the upper surface of the toner cartridge C, and the intake port 20 may be disposed on the rear side or the upper surface of the toner cartridge C. Further, if there is enough space in the apparatus body 100, the discharge port 16a and the intake port 20 may be disposed on both right and left side surfaces among the respective side surfaces of the toner cartridge C.

Further, the first frame body 32 of the toner cartridge C supports the lid member 30 that seals the discharge port 16a rotatably about a pivot shaft 30a. In a state where the toner cartridge C is not attached to the apparatus body 100 and the discharge port 16a of the toner cartridge C is not connected to the passage 24, the lid member 30 is positioned at the closed position illustrated in FIG. 3A. In the closed position, the lid member 30 seals the discharge port 16a and suppresses toner within the toner chamber 16 from leaking to the exterior of the toner cartridge C.

Meanwhile, in a state where the toner cartridge C is attached to the apparatus body 100 and the discharge port 16a of the toner cartridge C is connected to the passage 24 serving as a tube, the lid member 30 is positioned at the opened position illustrated in FIG. 3B. The lid member 30 opens the discharge port 16a in the opened position, and allows toner T to be supplied from the toner cartridge C via the passage 24 to the process cartridge B. The lid member 30 is not limited to an open/close member as according to the present embodiment, and for example, it may be composed of a sealing member that may be detachably attached to the toner cartridge C or a sliding member that may be slid with respect to the toner cartridge C.

As illustrated in FIGS. 3A to 5, the first frame body 32 includes a first box portion that forms the toner chamber 16, and a first flange portion 32a that extends in the approximately horizontal direction from the lower end portion of the first box portion toward the outer side of the toner chamber 16. The first box portion is formed in an approximately rectangular parallelepiped shape. The first flange portion 32a is formed across an entire circumference of a lower end portion of the first box portion.

Further, as illustrated in FIG. 8, a plurality of ribs 32d are disposed on an inner wall of the first box portion of the first frame body 32. The plurality of ribs 32d extend toward the inner side of the toner chamber 16 in correspondence with a region in which a second flange portion 31a of the second frame body 31 is formed. The plurality of ribs 32d face the second flange portion 31a of the second frame body 31 in the Y direction.

The second frame body 31 is formed as a separate member as the first frame body 32, and includes a second box portion that forms the air chamber 17 and the second flange portion 31a that extends in an approximately horizontal direction from an upper end portion of the second box portion toward the outer side of the air chamber 17. The second flange portion 31a is formed across an entire circumference of the upper end portion of the second box portion.

The filter 18 includes, as illustrated in FIGS. 3A to 6, a bottom surface portion 18e that partitions the air chamber 17 and the toner chamber 16, and an outer edge portion 18a that is sandwiched between and held by the first flange portion 32a and the second flange portion 31a. The bottom surface portion 18e is composed of a plurality of inclined portions 18c that are formed to extend downward in the gravity direction G as it approaches a lowest portion 18b of the filter 18, and constitutes a bottom surface of the toner chamber 16. The lowest portion 18b is disposed at a center portion of the filter 18 in the X direction and the Z direction. In other words, the filter 18 includes the bottom surface portion 18e that serves as a partition portion partitioning the toner chamber 16 and the air chamber 17 such that at least a portion of the toner chamber 16 is positioned above the air chamber 17 in the gravity direction G.

The filter 18 is composed of a filter material formed by hot pressing or of a fibrous sheet material. Furter, the filter 18 is formed of a single continuous member, and the bottom surface portion 18e of the filter 18 is configured to be parallel with the bottom surface shape of the second frame body 31. Toner T in the toner chamber 16 is loaded on the bottom surface portion 18e of the filter 18.

The frame body of the toner cartridge C is formed by mutually joining the first flange portion 32a and the second flange portion 31a by ultrasonic welding, such that no air leaks between the first flange portion 32a and the second flange portion 31a. The joining of the first flange portion 32a and the second flange portion 31a is not limited to ultrasonic welding, and the portions may be fixed by thermal welding, by an adhesive such as double-sided tape or hot melting, or through use of a screw.

By joining the first flange portion 32a and the second flange portion 31a, the outer edge portion 18a of the filter 18 and a sealing member 34 are sandwiched between the plurality of ribs 32d of the first frame body 32 and the second flange portion 31a. The sealing member 34 is composed of a member having flexibility, such as rubber or silicon. As described, the filter 18 is held by being sandwiched together with the sealing member 34 between the first frame body 32 and the second frame body 31. If the holding force of the filter 18 is insufficient, it may be possible to bond the entire circumference of the outer edge portion 18a of the filter 18 to at least either one of the first flange portion 32a and the second flange portion 31a. Thereby, the filter 18 may be held with a high holding force. Further, the sealing member 34 may be omitted.

A tubular discharge pipe 27 is arranged in the interior of the toner chamber 16, as illustrated in FIGS. 3A to 5. The discharge pipe 27 includes an inlet 27a that opens downward in the gravity direction G, and an outlet 27b that opens rearward, that is, upstream in the X direction, that communicates with the discharge port 16a of the toner cartridge C and that is passed through to the exterior of the toner cartridge C. The outlet 27b is connected to the discharge port 16a, and is positioned above the inlet 27a. The discharge pipe 27 includes a first pipe portion that extends in the Y direction or the gravity direction G and to which the inlet 27a is disposed, and a second pipe portion that extends in the X direction and to which the outlet 27b connected to the discharge port 16a is disposed, wherein the discharge pipe 27 is bend in midway. As described, the discharge pipe 27 connects the inlet 27a and the outlet 27b. The inlet 27a at an opposite end portion of the outlet 27b of the discharge pipe 27 is arranged to face the lowest portion 18b, which is the portion of the filter 18, with a gap therebetween in the gravity direction G. The discharge pipe 27 is composed arbitrary of a tube having flexibility formed of a resin material such as rubber or a silicon material, or a hollow member formed of a pipe made of resin or metal.

As illustrated in FIGS. 4 and 8, supporting portions 32b and 32c are extended from the inner circumferential surface of the first frame body 32. The supporting portion 32b extends in the-Y direction, i.e., the gravity direction G, from the inner circumferential surface of the upper surface side of the first frame body 32, and the supporting portion 32c extends in the X direction from the inner circumferential surface on the rear side of the first frame body. The supporting portions 32b and 32c respectively support the area of the discharge pipe 27 near the inlet 27a and the area thereof near the outlet 27b. The supporting portions 32b and 32c may be formed integrally with the first box portion of the first frame body 32 when forming the first frame body 32, or it may be formed as a separate member as the first box portion.

### Toner Conveyance Mechanism

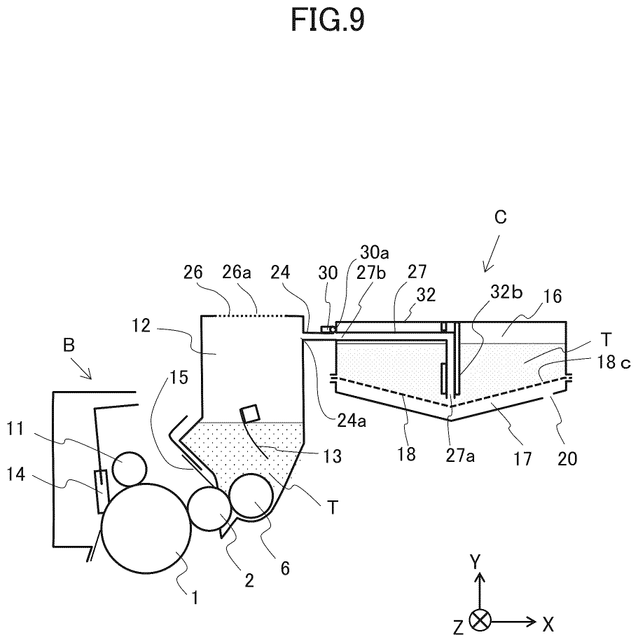

Next, a mechanism by which toner accommodated in the toner chamber 16 of the toner cartridge C is conveyed to the developer container 12 of the process cartridge B will be described with reference to FIGS. 1, 3A, 3B, and 9. FIG. 9 is a cross-sectional view illustrating a state in which the toner cartridge C is connected to the developer container 12 via the passage 24. As illustrated in FIGS. 1 and 9, air discharged from the pump 35 is taken into the air chamber 17 via the air supply pipe 21 and the intake port 20 of the toner cartridge C. Then, the air is filled in the air chamber 17 and passed through the filter 18 to flow into the toner chamber 16.

The air flown into the toner chamber 16 enters through particles of toner T and thereby fluidizes toner T. The interior of the toner cartridge C is set to positive pressure by the air flowing therein from the pump 35, and air attempts to exit to the exterior of the toner cartridge C through the discharge port 16a via the discharge pipe 27. In this state, toner T within the toner chamber 16 is caused to move together with air into the discharge pipe 27 through the discharge port 16a to be discharged to the exterior of the toner cartridge C. That is, the discharge pipe 27 guides toner within the toner chamber 16 together with air from the inlet 27a to the discharge port 16a.

By disposing the air chamber 17, which is an airtight space, between the pump 35 and the filter 18, as according to the present embodiment, the air discharged from the pump 35 heads toward the filter 18 efficiently without being dispersed to the exterior of the toner cartridge C. For example, in a state where toner T within the toner chamber 16 of the toner cartridge C is aggregated, such as by being vibrated or being left as it is for a long time, a high pressure may be required to flow air through the filter 18 into the toner chamber 16. Even in such a case, by sending air continuously from the pump 35 into the air chamber 17 and increasing the pressure, i.e., air pressure, within the air chamber 17, air may be sent into the toner chamber 16 through the filter 18. Further, by disposing the air chamber 17, the pump 35 is only required to have an ability to generate enough pressure to send air continuously into the air chamber 17 until a necessary pressure is produced to allow air to pass through the filter 18 into the toner chamber 16. Therefore, a small-sized pump may be adopted as the pump 35, which contributes to downsizing the apparatus.

According further to the present embodiment, the only exit of air taken in through the intake port 20 to the toner cartridge C is the discharge port 16a. Therefore, the flow of air within the toner cartridge C is stabilized, and toner T accommodated in the toner chamber 16 can be discharged stably to the exterior of the toner cartridge.

Even further, by providing no ventilation hole or discharge port other than the single discharge port 16a to the toner cartridge C, discharge of toner T may be performed stably by only the force of the pump 35 discharging air toward the intake port 20. In a state where a plurality of air discharge ports are disposed, it becomes difficult to control the flow of toner and air, such that in order to convey toner stably, a configuration is required to suck in toner and air and to discharge the same to the exterior of the toner cartridge C. According to the present embodiment, toner T may be discharged stably without providing another pump for sucking in air, such that the conveyance of toner T may be realized stably by a simple configuration.

Toner T discharged from the discharge port 16a is replenished via the passage 24 to an upstream end portion of the developer container 12 in the Y direction. The agitating member 13 that agitates toner within the developer container 12 is disposed rotatably in the toner accommodating portion 12a of the developer container 12, as illustrated in FIG. 2.

Toner within the toner accommodating portion 12a is leveled by the rotation of the agitating member 13. In the present embodiment, the agitating member 13 is composed of the rotation shaft 13a and the agitating sheet 13b fixed to the rotation shaft 13a, but the present technique is not limited thereto. For example, the agitating member 13 may be composed of a screw configured to convey toner within the toner accommodating portion 12a of the developer container 12 along the Z direction.

Not only toner T but also air flows into the developer container 12, such that the internal pressure within the developer container 12 rises. Therefore, according to the present embodiment, as illustrated in FIGS. 3A, 3B, and 9, the opening 26 is formed on the upper surface of the developer container 12, and the opening 26 is covered by the filter 26a. Thereby, toner flowing into the developer container 12 is regulated from being discharged to the exterior by the filter 26a, and remains within the developer container 12. Meanwhile, at least a portion of air flown into the developer container 12 passes through the filter 26a and is discharged to the exterior of the developer container 12. Thereby, the rising of internal pressure of the developer container 12 is suppressed, and replenishment of toner to the developer container 12 may be performed smoothly.

As described above, toner accommodated in the toner cartridge C is conveyed together with air to the developer container 12 and replenished into the developer container 12. Since toner is conveyed using air, the freedom of design of the toner conveyance path is enhanced, and since there is no need for a member such as a screw for conveying toner, the number of components may be reduced and costs may be cut down.

Further, as described above, the inlet 27a of the discharge pipe 27 is arranged to face the lowest portion 18b of the filter 18 with a gap formed therebetween. The filter 18 is held at a position inclined downward toward the lowest portion 18b, such that when the remaining amount of toner within the toner chamber 16 is reduced, toner fluidized by air moves along the inclination of the filter 18 and gathers at the lowest portion 18b. In other words, toner within the toner chamber 16 may be guided toward the inlet 27a of the discharge pipe 27.

Therefore, even if the amount of toner remaining is the toner chamber 16 becomes low, toner gathered at the lowest portion 18b may be discharged from the inlet 27a of the discharge pipe 27 efficiently via the discharge port 16a to the exterior of the toner cartridge C. The discharge port 16a is arranged above the inlet 27a and the bottom surface portion 18e of the filter 18, and toner is conveyed by air from the inlet 27a to the discharge port 16a. Therefore, the amount of toner that remains within the toner chamber 16 without being replenished may be reduced.

### Relationship of Pressure at Respective Portions during Toner Conveyance

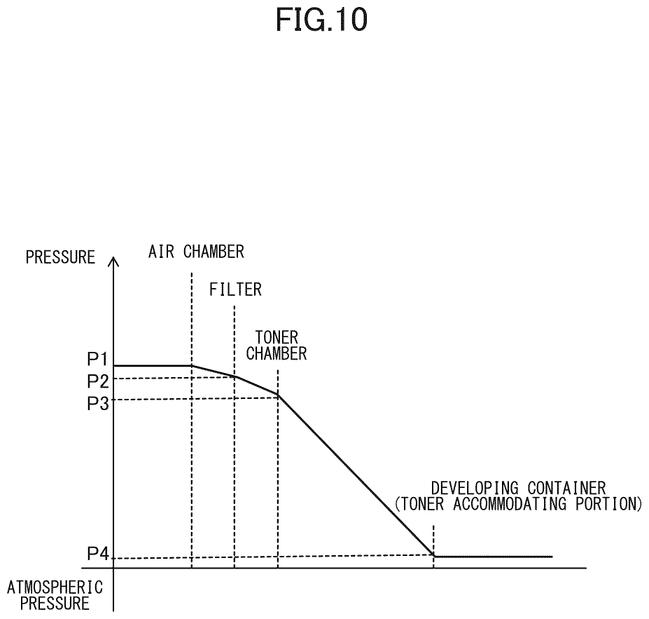

Next, with reference to FIG. 10, pressure at respective portions along a conveyance path while a toner conveyance operation for conveying toner from the toner cartridge C to the developer container 12 using air sent from the pump 35 is performed will be described. In the toner conveyance operation, the air being discharged from the pump 35, which corresponds to the air being taken in through the intake port 20 of the toner cartridge C, causes toner in the toner chamber 16 to be discharged through the discharge port 16a and conveyed via the passage 24 to the toner accommodating portion 12a. FIG. 10 is a graph illustrating the pressure at respective portions in a state where the pressure generated by the pump 35 is transmitted from the toner cartridge C to the process cartridge B.

As illustrated in FIG. 10, a pressure P1 generated by the pump 35 drops slightly to a pressure P2 at the air chamber 17 of the toner cartridge C by passing through the air supply pipe 21. Then, the pressure drops corresponding to an amount of pressure loss that occurs when air passes through the filter 18, and the pressure in the toner chamber 16 will become a pressure P3. Further, the pressure drops corresponding to an amount of pressure loss that occurs when air and toner from the toner chamber 16 passes through the passage 24, such that the pressure in the toner accommodating portion 12a of the developer container 12 of the process cartridge B will become a pressure P4.

The developer container 12 of the process cartridge B is communicated with the exterior of the developer container 12 through the opening 26, such that the pressure within the developer container 12 may be maintained to a value close to atmospheric pressure. As described, the toner cartridge C and the process cartridge B are pressurized by the pump 35 such that pressure is constantly increased. The pressure P1 applied on the pump 35 is a value obtained by adding, to the pressure P4 of the developer container 12, a pressure loss (P4-P3) when air and toner T passes through the passage 24, a pressure loss (P3-P2) when air passes through the filter 18, and a pressure loss (P2-P1) when air passes through the air supply pipe 21. It may be possible to ignore the pressure loss at the air supply pipe 21 by arranging the pump 35 and the toner cartridge C closely and to either omit the air supply pipe 21 or shorten the air supply pipe 21 between the pump 35 and the toner cartridge C.

### Transition of Toner Discharge State

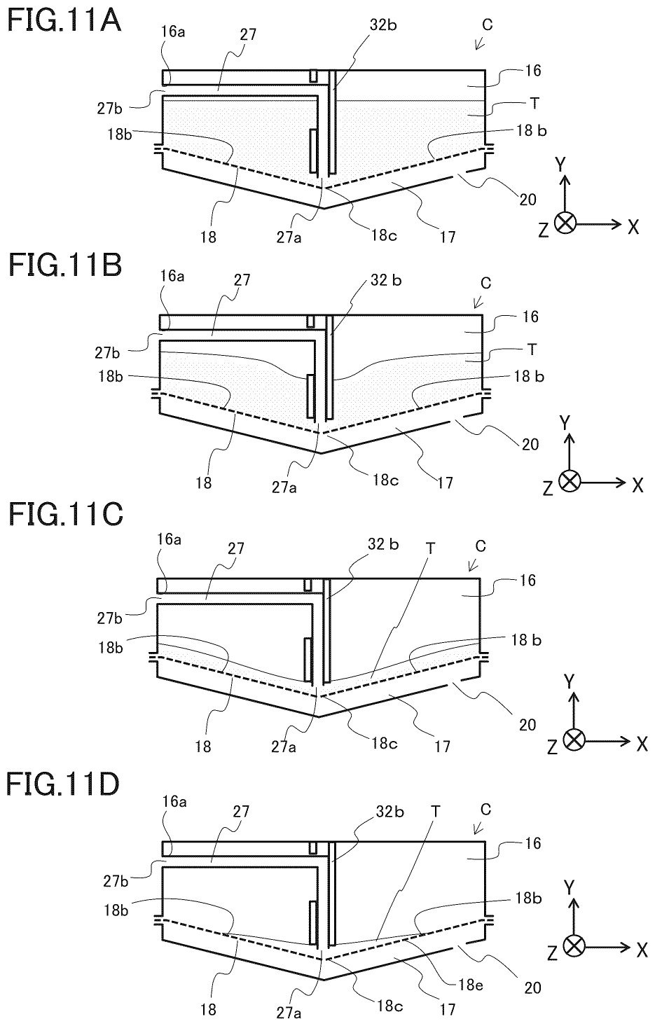

FIGS. 11A to 11D are each a cross-sectional view illustrating a transition of discharge state when toner T accommodated in the toner chamber 16 is discharged from the toner cartridge C. FIG. 11A is a cross-sectional view illustrating a state in which the discharge of toner T is not started, and FIG. 11B is a cross-sectional view illustrating a state in which the discharge of toner T has been started by air being taken in through the intake port 20. FIG. 11C is a cross-sectional view illustrating a state in which toner T has been discharged further from the state of FIG. 11B, and FIG. 11D is a cross-sectional view illustrating a state in which the inclined portions 18c of the filter 18 are partially exposed.

As illustrated in FIG. 11A, when air is sent into the air chamber 17 of the toner cartridge C through the intake port 20 by the pump 35, air flows toward the only exist of the toner cartridge C, which is the discharge port 16c, via the filter 18 and the discharge pipe 27. In this state, air is flown together with toner T, such that toner T enters the inlet 27a together with air, is conveyed through the discharge pipe 27 toward the discharge port 16a, and is discharged through the discharge port 16a. Thereby, toner T accommodated in the toner chamber 16 is reduced, and transition from the state of FIG. 11A to the state of FIG. 11B occurs.

As illustrated in FIG. 11B, when toner T within the toner chamber 16 is reduced through discharge of toner T, the agent surface of toner T in the vicinity of the inlet 27a lowers with respect to the gravity direction. Thereby, toner T accommodated in the toner chamber 16 starts to collapse from the circumference of the inlet 27a. In this state, since toner T is fluidized by the flowing in of air having passed through the filter 18, toner T is conveyed along the inclined surface of the inclined portions 18c toward the lowest portion 18b. In a state where flowing in of air from the intake port 20 is continued, toner T in the vicinity of the lowest portion 18b enters through the inlet 27a into the discharge pipe 27, is passed through the discharge pipe 27 together with air, and is discharged through the discharge port 16a. In a state where the discharge of toner T is performed continuously, the agent surface of toner T accommodated in the toner chamber 16 is further lowered, and transition occurs from the state of FIG. 11B to the state of FIG. 11C and further to the state of FIG. 11D.

As illustrated in FIG. 11D, when toner T in the toner accommodating portion 12a is reduced, a portion of the inclined portions 18c of the filter 18 is exposed. In this state, an air permeation amount of the filter 18 and a pump flow rate are set as described later, such that air discharged from the pump 35 is discharged through the entire surface of the bottom surface portion 18e of the filter 18, regardless of the presence of toner on the filter 18.

### Relationship between Air Permeation Amount of Filter and Pump Flow Rate

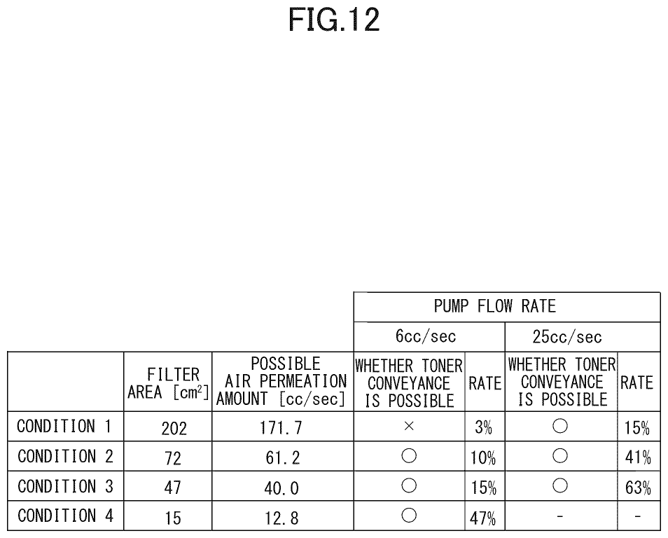

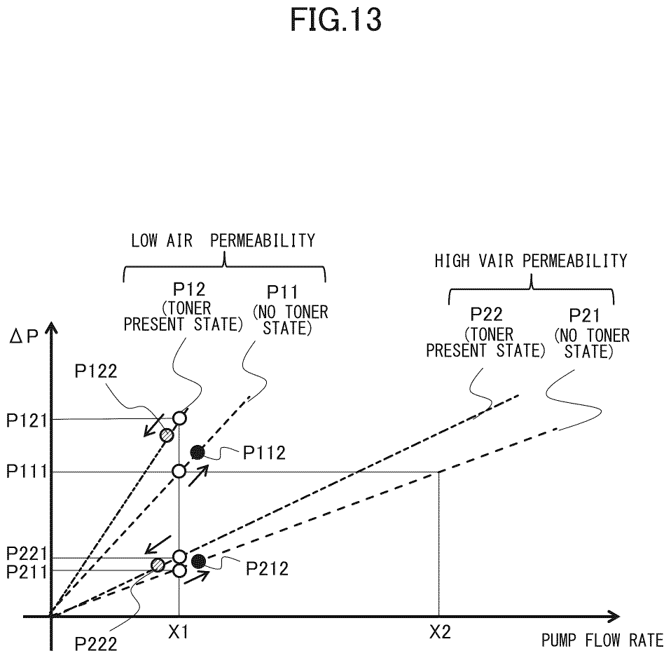

Next, an air permeation amount of the filter 18 and a pump flow rate required for fluidization of toner T within the toner chamber 16 by the air passing through the filter 18 will be described with reference to FIGS. 12 and 13. FIG. 12 is a table illustrating whether toner conveyance is possible according to respective conditions. FIG. 13 is a graph illustrating a relationship between pump flow rate and pressure difference between the air chamber 17 and the toner chamber 16.

An air permeability indicating a ventilation performance of the filter 18 disposed in the toner cartridge C is shown using a unit of [cm³/(cm²·s)], and an air flow rate of air passing through the filter 18 per unit area when air is sucked in to realize a pressure of 125 [Pa] is indicated. For example, the air permeability may be measured using A method, i.e., Frazier method, prescribed by a JIS L1096 ventilation test. According to the A method, i.e., Frazier method, five test pieces of approximately 200 [mm]×200 [mm] are acquired. Next, the test pieces are attached to a Frazier testing device, air is sucked therethrough to realize a pressure of 125 [Pa], and the air flow rate in that state is measured. Based on the measured air flow rate and the testing area, the air permeability [cm³/(cm²·s)] is obtained.

A filter having a low air permeability may be considered as a filter having a small opening area per unit area. Therefore, when air of a same flow rate is blown to a filter having a low air permeability and a filter having a high air permeability, the filter having the low air permeability will realize a faster flow speed at the opening portion of the filter. Therefore, in order to cause toner T that is settled on the filter by its own weight, like the toner within the toner chamber 16, to float by buoyancy by flow speed of air and fluidize, it is advantageous to use a filter having a low air permeability. Further, in the case of a filter having a low air permeability, toner T within the toner chamber 16 may be fluidized using a pump 35 having a low flow rate.

FIG. 12 illustrates a result of determining whether toner conveyance is possible based on a ratio of air permeation amount of the filter 18 and the pump flow rate regarding the filter 18 having an air permeability of 0.9 [cm³/(cm²·s)]. In FIG. 12, the areas of the filter 18 are varied as according to conditions 1 to 4.

That is, according to condition 1, a filter area is 202 [cm²] and a possible air permeation amount of the filter 18 is 171.7 [cc/sec]. The possible air permeation amount of the filter 18 may be obtained based on the air permeability of the filter 18 and the filter area. According to condition 2, the filter area is 72 [cm²] and the possible air permeation amount of the filter 18 is 61.2 [cc/sec]. According to condition 3, the filter area is 47 [cm²] and the possible air permeation amount of the filter 18 is 40.0 [cc/sec]. According to condition 4, the filter area is 15 [cm²] and the possible air permeation amount of the filter 18 is 12.8 [cc/sec].

Whether toner conveyance is possible in cases where the pump flow rate is set to 6 [cc/sec] and to 25 [cc/sec] according to respective conditions 1 to 4 is illustrated in FIG. 12. Whether toner conveyance is possible indicates whether toner T within the toner chamber 16 of the toner cartridge C may be conveyed via the passage 24 to the toner accommodating portion 12a of the developer container 12 of the process cartridge B by driving the pump 35 during the toner conveyance operation.

Based on the result illustrated in FIG. 12, it has been discovered that toner conveyance becomes possible in a case where the filter 18 and the pump 35 are selected such that the pump flow rate is 10% or higher with respect to the possible air permeation amount of the filter 18. In other words, in order to enable toner to be conveyed to the developer container 12 by air sent from the pump 35, it is necessary for the pump flow rate to be 10% or higher with respect to the air permeation amount of the filter 18.

Next, an influence of the air permeability of the filter 18 and the pump flow rate on a pressure difference between the air chamber 17 and the toner chamber 16, hereinafter simply referred to as a pressure difference ΔP, will be described with reference to FIG. 13. A horizontal axis of FIG. 13 indicates the pump flow rate, and a vertical axis of FIG. 13 indicates the pressure difference ΔP. A straight line P11 of FIG. 13 illustrates a relationship between the pump flow rate and the pressure difference ΔP when the pump 35 is driven in a state where no toner T is loaded on the entire surface of the bottom surface portion 18e, which is hereinafter referred to as a no toner state, of the filter 18 having a low air permeability. A straight line P21 illustrates a relationship between the pump flow rate and the pressure difference ΔP when the pump 35 is driven in a state where no toner T is loaded on the bottom surface portion 18e of the filter 18 having a high air permeability. A straight line P12 illustrates a relationship between the pump flow rate and the pressure difference ΔP when the pump 35 is driven in a state where toner T is loaded on the entire surface of the bottom surface portion 18e, which is hereinafter referred to as a toner present state, of the filter 18 having a low air permeability. A straight line P22 illustrates a relationship between the pump flow rate and the pressure difference ΔP when the pump 35 is driven in a state where toner T is loaded on the entire surface of the bottom surface portion 18e of the filter 18 having a high air permeability.

As can be recognized from the straight lines P11, P12, P21, and P22, the pressure difference ΔP increases as the pump flow rate increases. Further, as can be recognized from the straight line P11, the pressure difference ΔP in a case where the filter 18 having a low air permeability and the pump 35 having a pump flow rate X1 is adopted will be a value P111. As can be recognized from the straight line P21, the pressure difference ΔP in a case where the filter 18 having a high air permeability and the pump 35 having a pump flow rate X1 is adopted will be a value P211 which is lower than the value P111. That is, as for the filter 18 having a high air permeability, the pump flow rate must be increased from pump flow rate X1 to pump flow rate X2 so as to realize the same pressure difference as the filter 18 having a low air permeability.

Further, as can be recognized from the straight line P12, in the toner present state, the pressure difference ΔP will be a value P121 in the case where the pump flow rate X1 is adopted. The value P121 is greater than the value P111. As can be recognized from the straight line P22, in the toner present state, the pressure difference ΔP will be a value P221 in the case where the pump flow rate X1 is adopted. The value 221 is greater than the value 211. As described, in a case where the conditions of the air permeability of the filter 18 and the pump flow rate are the same, it can be recognized that the pressure difference ΔP will be greater in the toner present state than in the no toner state. This is because when toner T is loaded on the bottom surface portion 18e of the filter 18, pressure loss occurs when air passes through toner T.

The gap of the pressure difference ΔP between the toner present state and the no toner state in a filter having a low air permeability is P121-P111. The gap of the pressure difference ΔP between the toner present state and the no toner state in a filter having a high air permeability is P221-P211. Since (P121-P111) is greater than (P221-P211), it is recognized that the filter having a lower air permeability has a greater gap of the pressure difference ΔP between the toner present state and the no toner state. Greater gap of the pressure difference ΔP between the toner present state and the no toner state is more advantageous for the fluidization of toner T.

As illustrated in FIG. 11D, a state in which toner T is loaded on only a part of the bottom surface portion 18e of the filter 18 and a part of the bottom surface portion 18e is exposed is referred to as a toner partially present state. In the toner partially present state, in the area where toner is loaded on the filter 18 having a low air permeability, the air permeation amount is reduced compared to a part where no toner is loaded. Therefore, the pressure difference is recognized to be a pressure difference ΔP in the case of a flow rate somewhat lower than the pump flow rate X1, for example, and the pressure difference ΔP will be a value P122. Further, in the area where no toner is loaded on the filter 18 having a low air permeability, the air permeation amount is increased compared to the part where toner is loaded. Therefore, the pressure difference may be recognized to be a pressure difference ΔP in the case of a flow rate somewhat higher than the pump flow rate X1, for example, and the pressure difference ΔP will be a value P112. The values P112 and P122 are both higher than the value P111.

Similarly, in the toner partially present state, in the area where toner is loaded on the filter 18 having a high air permeability, the air permeation amount is reduced compared to the area where no toner is loaded. Therefore, the pressure difference is recognized to be a pressure difference ΔP in the case of a flow rate somewhat lower than the pump flow rate X1, for example, and the pressure difference ΔP will be a value P222. Further, in the area where no toner is loaded on the filter 18 having a high air permeability, the air permeation amount is increased compared to the area where toner is present. Therefore, the pressure difference may be recognized to be a pressure difference ΔP in the case of a flow rate somewhat higher than the pump flow rate X1, for example, and the pressure difference ΔP will be a value P212. The values P212 and P222 are both higher than the value P211.

The pressure difference ΔP between the air chamber 17 and the toner chamber 16 corresponds to the pressure loss that occurs when air passes through the filter 18. As illustrated in FIG. 13, when the pump flow rate is gradually increased, the pressure loss caused by the filter 18 is also gradually increased. As described above, in order to enable toner conveyance to the developer container 12 by the pump 35, it is necessary for the pump flow rate to be 10% or more with respect to the air permeation amount of the filter 18. Meanwhile, even if air is supplied to the filter 18 exceeding the air permeation amount of the filter 18, the pressure loss by the filter 18 is merely increased. Therefore, from the viewpoint of saving energy, the pump flow rate with respect to the air permeation amount of the filter 18 is preferably 100% or less.

### Method for Confirming Toner Fluidization Condition

Next, a method for verifying whether air is blown out through the entire surface of the bottom surface portion 18e of the filter 18 regardless of whether toner is loaded on the bottom surface portion 18e of the filter 18 will be described. For example, in the toner partially present state, if air flows out only from the area of the filter 18 where no toner is loaded, toner within the toner chamber 16 will not be fluidized appropriately by air.

As for the method for verifying the state described above, while the toner conveyance operation is performed, the pressure within the air chamber 17 and the pressure within the toner chamber 16 are respectively measured, and a pressure difference ΔP is calculated. The pressure difference ΔP is calculated based on two conditions, which are a no toner state and a toner partially present state. When the pressure difference ΔP in the toner partially present state is greater than the pressure difference ΔP in the no toner state, it can be confirmed that air is blown out through the entire surface of the bottom surface portion 18e of the filter 18. When the pressure difference ΔP in the toner partially present state and the pressure difference ΔP in the no toner state are the same, it can be considered that air is only passed through the area of the filter 18 where no toner is loaded in the toner partially present state. Therefore, air cannot be blown out at areas of the filter 18 where toner is loaded, and toner T cannot be fluidized appropriately.

Compared to the no toner state, in the case of the toner partially present state or the toner present state, the pressure within the air chamber 17 becomes high. This is because toner loaded on the bottom surface portion 18e of the filter 18 serves as a resistance when air passes through. Therefore, when the pressure of the air chamber 17 in the toner partially present state is greater than the pressure of the air chamber 17 in the no toner state, it can be confirmed that air is blown out from the entire surface of the bottom surface portion 18e of the filter 18.

Further, the inclination angle of the inclined portions 18c or the flow rate of air supplied from the pump 35 also affects the discharge property of toner T. It is effective to increase the angle of the inclined portions 18c to discharge toner T from the entire area of the toner chamber 16. However, if the angle of the inclined portions 18c is too large, the volume of toner T that may be accommodated in the toner chamber 16 will be reduced compared to a configuration where the angle of the inclined portions 18c is small. Then, it may be difficult to achieve downsizing of the toner cartridge C if a desired amount of toner T is to be accommodated. Therefore, from the viewpoint of ensuring capacity and downsizing of the toner cartridge C, it is preferable to set the angle of the inclined portions 18c as small as possible within the range in which discharge of toner T can be realized.

### Positioning of Discharge Pipe

As illustrated in FIGS. 3A and 3B, the first frame body 32 may position the discharge pipe 27 such that the inlet 27a faces the lowest portion 18b of the filter 18 by engaging the supporting portion 32b and the discharge pipe 27. The position of the inlet 27a within the toner chamber 16 with respect to the lowest portion 18b of the filter 18 affects the discharge property of toner T. As illustrated in FIGS. 11A to 11C, toner T accommodated in the toner chamber 16 fluidizes by the flowing in of air, and is conveyed toward the lowest portion 18b by the configuration of the inclined portions 18c. Therefore, according to the configuration of the present embodiment, it is most desirable from the viewpoint of discharge of toner T to dispose the inlet 27a in the vicinity of the lowest portion 18b.

Specifically, as illustrated in FIG. 11C, in a state where toner T within the toner chamber 16 is reduced, if the position of the inlet 27a is moved to a position where there is little toner T or where no toner T exists, it becomes difficult to send toner T into the discharge pipe 27 even when air is taken in through the intake port 20. Then, compared to a state in which the inlet 27a is positioned near the lowest portion 18b, the amount of toner T remaining in the toner chamber 16 may be increased. That is, by reliably positioning the inlet 27a, toner T may be discharged from the toner cartridge C to the exterior in a stable manner. Further, the amount of toner T remaining in the toner chamber 16 may be managed, and in a state where toner T may not be discharged through the discharge port 16a by the inflow of air through the intake port 20, it becomes possible to suppress toner T from remaining excessively in the toner chamber 16.

As described above, according to the present embodiment, while the toner conveyance operation is performed, the pressure of respective portions are set to realize the relationship of FIG. 10. That is, the pressure P1 of the pump 35, the pressure P2 of the air chamber 17, the pressure P3 of the toner chamber 16, and the pressure P4 of the toner accommodating portion 12a are equal to or greater than atmospheric pressure, and the pressure P3 of the toner chamber 16 is greater than the pressure P4 of the toner accommodating portion 12a. Thereby, toner T within the toner chamber 16 may be conveyed to the toner accommodating portion 12a by air being sent from the pump 35. Further, since the pressure P2 of the air chamber 17 is greater than the pressure P3 of the toner chamber 16, air can be sent through the filter 18 into the toner chamber 16, and toner T loaded on the bottom surface portion 18e of the filter 18 may be fluidized. The pressures P1 to P4 are merely examples, and as long as the relationship of magnitude among the respective pressures is satisfied as described above, the values of the respective pressures P1 to P4 may be set arbitrarily. The pressures P1 to P4 are determined by the pump flow rate of the pump 35, the air permeation amount of the filter 18, the pressure loss at the air supply pipe 21, and the pressure loss at the passage 24. The pressure losses at the air supply pipe 21 and the passage 24 are determined by the inner diameters, cross-sectional areas, lengths, and arrangements of the air supply pipe 21 and the passage 24.

Further, the opening 26 is disposed on the developer container 12, and the opening 26 is covered by the filter 26a serving as a developing filter, such that at least a portion of air having flown into the developer container 12 may be discharged to the exterior of the developer container 12. Specifically, the amount of air taken into the toner cartridge C from the pump 35 is lower than the sum of the amount of air taken into the developer container 12 via the passage 24 and the amount of air that may be discharged to the exterior of the developer container 12 via the opening 26 and the filter 26a. Therefore, the rising of internal pressure of the developer container 12 may be suppressed, the toner T may be conveyed smoothly from the toner cartridge C to the developer container 12 while suppressing leakage of toner from the developer container 12.

According to the present embodiment, the air permeability of the filter 18 disposed on the toner cartridge C is 1/15 or more and 1/5 or less of the air permeability of the filter 26a that covers the opening 26 of the developer container 12. For example, the air permeability of the filter 18 is 0.9 [cm³/(cm²·s)], and the air permeability of the filter 26a is 11.0 [cm³/(cm²·s)]. In order to lower the internal pressure of the developer container 12, the air permeability of the filter 26a is preferably great within a level not causing toner leakage through the filter 26a to the exterior of the developer container 12. For example, if the air permeability of the filter 26a exceeds 11.0 [cm³/(cm²·s)], toner may leak through the filter 26a.

Meanwhile, lower air permeability of the filter 18 is advantageous for fluidizing toner within the toner chamber 16. If the air permeability of the filter 18 is low, the pressure difference between the air chamber 17 and the toner chamber 16 may be increased, which causes the flow speed of air passing through the filter 18 to increase and to enhance the fluidization effect of toner. However, if the air permeability of the filter 18 is too low, the pressure loss at the filter 18 becomes excessive, such that the pump flow rate must be raised to realize toner conveyance. Considering the balance between the above-mentioned states, the air permeability of the filter 18 is preferably 1/15 or more and 1/5 or less of the air permeability of the filter 26a.

According further to the present embodiment, in a toner partially present state in which toner T is loaded on only a part of the bottom surface portion 18e, the air permeation amount of the filter 18 and the pump flow rate are set such that air blows out, i.e., passes, through the entire surface of the bottom surface portion 18e of the filter 18. More specifically, while the toner conveyance operation is performed, the air permeability of the filter 18 is set such that the pressure difference ΔP between the toner chamber 16 and the air chamber 17 in the toner partially present state serving as a first state is greater than the pressure difference ΔP in the no toner state serving as a second state. In this state, the pressure of the air chamber 17 in the toner partially present state is greater than the pressure of the air chamber 17 in the no toner state. Therefore, even in the toner partially present state, air may be passed through the area where toner is present on the bottom surface portion 18e of the filter 18, such that toner T may be loosened and fluidized. Further, by such fluidization of toner using air, toner loaded on the inclined portions 18c of the filter 18 may collapse toward the lowest portion 18b, and toner is gathered at the inlet 27a of the discharge pipe 27, such that the amount of toner T remaining in the toner chamber 16 may be suppressed.

According to the present embodiment, while the toner conveyance operation is performed, the pump flow rate of the pump 35 is set to 10% or more and 100% or less of the air permeation amount of the filter 18. By setting the pump flow rate to be 10% or more of the air permeation amount of the filter 18, toner may be conveyed reliably from the toner cartridge C to the developer container 12 by air being sent from the pump 35. Further, by setting the pump flow rate to be 100% or less of the air permeation amount of the filter 18, the pressure loss at the filter 18 may be suppressed, energy-saving performance may be enhanced, and downsizing of the pump 35 may be realized. The air permeation amount of the filter 18 may be calculated based on the air permeability of the filter 18 and the area of the bottom surface portion 18e.

### Other Embodiments

The embodiment described above has been illustrated based on a configuration of the toner cartridge C that may be attached to and detached from the apparatus body 100, but the present disclosure is not limited thereto. The present disclosure is also applicable to an all-in-one cartridge in which the toner cartridge C and the process cartridge B are integrated, or a cartridge in which the toner cartridge C and the developing unit are integrated, according to which similar effects as those described above may be achieved.

According further to the embodiment described above, the image forming apparatus IF was illustrated as a monochrome image forming apparatus, but the present technique is not limited thereto. For example, the image forming apparatus IF may be a full-color image forming apparatus. In that case, similar effects as the present technique may be achieved by adopting the configurations described in the present disclosure to a plurality of toner cartridges accommodating toner of various colors and to process cartridges.

According even further to the embodiment described above, the discharge port 16a and the discharge pipe 27 were disposed on the toner chamber 16, but the present technique is not limited thereto. For example, the discharge port 16a may be disposed on the air chamber 17, the discharge pipe 27 may be formed to pass through a hole formed on the filter 18, the inlet 27a may face the lowest portion 18b of the filter 18, and the outlet 27b may be connected to the discharge port 16a.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-159538, filed Sep. 13, 2024, which is hereby incorporated by reference herein in its entirety.

What is claimed is:

1. An image forming apparatus comprising:
a cartridge configured to accommodate toner; and
an apparatus body to which the cartridge is detachably attached, the apparatus body including:
a pump portion configured to discharge air;
a developer container including a toner accommodating portion configured to accommodate the toner; and
a tube configured to convey the toner discharged together with air from the cartridge to the toner accommodating portion of the developer container,
wherein the cartridge includes:
a toner chamber configured to accommodate the toner;
a filter configured to block passage of the toner while allowing passage of air;
an air chamber arranged adjacent to the toner chamber via the filter, the air chamber being provided with an intake port that takes in air discharged from the pump portion;
a discharge port configured to discharge the toner accommodated in the toner chamber to an exterior of the cartridge; and
a pipe configured to communicate with the discharge port and through which the toner discharged from the discharge port passes,
wherein while a toner conveyance operation is performed in which the toner in the toner chamber is discharged from the discharge port and conveyed through the tube to the toner accommodating portion by air discharged from the pump portion and taken in through the intake port of the cartridge,
(i) a pressure of the pump portion, a pressure of the air chamber, a pressure of the toner chamber, and a pressure of the toner accommodating portion are equal to or greater than atmospheric pressure,
(ii) the pressure of the toner chamber is greater than the pressure of the toner accommodating portion, and
(iii) the pressure of the air chamber is greater than the pressure of the toner chamber, and
wherein the filter includes a partition portion configured to partition the toner chamber and the air chamber such that at least a portion of the toner chamber is positioned above the air chamber in a gravity direction, and
wherein while the toner conveyance operation is performed, a pressure difference between the toner chamber and the air chamber in a first state in which the toner is loaded on only a part of the partition portion of the filter is greater than a pressure difference between the toner chamber and the air chamber in a second state in which no toner is loaded on an entire surface of the partition portion of the filter.

2. The image forming apparatus according to claim 1, wherein while the toner conveyance operation is performed, the pressure of the air chamber in the first state is greater than the pressure of the air chamber in the second state.

3. The image forming apparatus according to claim 1, wherein while the toner conveyance operation is performed, a pump flow rate of the pump portion is 10% or more and 100% or less of an air permeation amount of the filter.

4. The image forming apparatus according to claim 1, wherein the filter is a first filter,
wherein the developer container is provided with an opening configured to communicate an interior of the toner accommodating portion with an exterior of the developer container, and
wherein the developer container includes a second filter configured to cover the opening and to block passage of the toner while allowing passage of air.

5. The image forming apparatus according to claim 4, wherein an air permeability of the first filter is lower than an air permeability of the second filter.

6. The image forming apparatus according to claim 1, wherein the pump portion includes a diaphragm pump.

7. The image forming apparatus according to claim 1, further comprising:
a first container configured to form the toner chamber together with the filter; and
a second container configured to form the air chamber together with the filter,
wherein the first container and the second container are joined to each other with an outer edge portion of the filter sandwiched therebetween.

8. The image forming apparatus according to claim 1, wherein the discharge port and the pipe are disposed on the toner chamber, and
wherein an end portion of the pipe opposite to an end portion connected to the discharge port is configured to open toward the filter.

9. An image forming apparatus comprising:
a cartridge configured to accommodate toner; and
an apparatus body to which the cartridge is detachably attached, the apparatus body including:
a pump portion configured to discharge air;
a developer container including a toner accommodating portion configured to accommodate the toner; and
a tube configured to convey the toner discharged together with air from the cartridge to the toner accommodating portion of the developer container,
wherein the cartridge includes:
a toner chamber configured to accommodate the toner;
a first filter configured to block passage of the toner while allowing passage of air;
an air chamber arranged adjacent to the toner chamber via the first filter, the air chamber being provided with an intake port that takes in air discharged from the pump portion;
a discharge port configured to discharge the toner accommodated in the toner chamber to an exterior of the cartridge; and
a pipe configured to communicate with the discharge port and through which the toner discharged from the discharge port passes, the toner in the toner chamber being discharged from the discharge port and conveyed through the tube to the toner accommodating portion by air discharged from the pump portion and taken in through the intake port of the cartridge,
wherein the developer container is provided with an opening configured to communicate the toner accommodating portion with an exterior of the developer container,
wherein the developer container includes a second filter configured to cover the opening and to block passage of the toner while allowing passage of air, and
wherein an air permeability of the first filter is lower than an air permeability of the second filter.

10. The image forming apparatus according to claim 9, wherein the air permeability of the first filter is 1/15 or more and 1/5 or less of the air permeability of the second filter.

11. The image forming apparatus according to claim 9, wherein while the toner accommodated in the toner chamber is being conveyed to the toner accommodating portion by air discharged from the pump portion, a pump flow rate of the pump portion is 10% or more and 100% or less of an air permeation amount of the first filter.

12. The image forming apparatus according to claim 9, wherein the pump portion includes a diaphragm pump.

13. The image forming apparatus according to claim 9, further comprising:
a first container configured to form the toner chamber together with the first filter; and
a second container configured to form the air chamber together with the first filter,
wherein the first container and the second container are joined to each other with an outer edge portion of the first filter sandwiched therebetween.

14. The image forming apparatus according to claim 9, wherein the discharge port and the pipe are disposed on the toner chamber, and
wherein an end portion of the pipe opposite to an end portion connected to the discharge port is configured to open toward the first filter.
